(19) United States
(12) Patent Application Publication
(10) Pub. No.: US 2026/0078743 A1
(43) Pub. Date: Mar. 19, 2026

(54) WIND TURBINE ROTOR BLADE WITH A HEATING ELEMENT

(71) Applicant: Nordex Energy SE & Co. KG, Hamburg (DE)

(72) Inventors: Thomas Lipka, Rostock (DE); Jochen Kremer, Hamburg (DE); Lars Pospischil, Hamburg (DE)

(21) Appl. No.: 19/329,325

(22) Filed: Sep. 15, 2025

(30) Foreign Application Priority Data
Sep. 16, 2024 (EP) 24200538.7

(51) Int. Cl. F03D 80/40

(52) U.S. Cl. CPC F03D 80/401

(57) ABSTRACT

A wind turbine rotor blade including a wind turbine rotor blade shell structure including a fiber reinforced composite material; an electrical heating element arranged on an outer surface of the wind turbine rotor blade shell structure, the electrical heating element having an electrical heating conductor with an end section; an electrical supply line running along a longitudinal direction of the wind turbine rotor blade; and, a connector connecting the end section of the heating conductor electrically to the electrical supply line wherein the connector includes an outer thread screwed directly into the fiber reinforced composite material and into the electrical supply line.

### CROSS-REFERENCE TO RELATED APPLICATIONS

This application claims priority of European patent application no. 24200538.7, filed Sep. 16, 2024, the entire content of which is incorporated herein by reference.

### TECHNICAL FIELD

The disclosure relates to a wind turbine rotor blade with an electrical heating element.

### BACKGROUND

WO 2022/263596 A1 shows a wind turbine rotor blade with an electrical heating mat arranged on an inner side of a wind turbine rotor blade shell. An electrical contact between the heating mat and a conductor cable arranged within the wind turbine rotor blade is made via metal patches. A disc-shaped metal block is in contact with the metal patch and is connected to a termination block of the conductor cable by drilling a hole from the exterior of the wind turbine rotor blade shell through the heating mat, the metallic patch, the disc-shaped metal block and into the termination block and by inserting a metallic connection element into the hole.

EP 2 526 292 B1 shows a wind turbine rotor blade with an electrical heating mat. The heating mat is wrapped in a copper mesh and arranged on an outer surface of the wind turbine rotor blade. A cable placed inside of the wind turbine rotor blade is connected to the heating mat by a bolt. The bolt is guided through a copper block placed on an outer side of the heating mat and is locked by a nut placed within the wind turbine rotor blade so that a clamping force is applied.

EP 2 843 228 A1 discloses a wind turbine rotor blade with an electrical heating system including a plurality of electrical heating elements arranged on an outer surface of a wind turbine rotor blade. Each of the heating elements has a carrier layer and a heating conductor arranged on the carrier layer between two opposite edges of the heating element in a meandering pattern. End sections of the heating conductor are connected to electrical supply lines arranged on the pressure side and on the suction side of the wind turbine rotor blade.

EP 2 754 891 B1 shows a wind turbine rotor blade with an electrical heating mat arranged on an outer side of a blade shell connected to a current supply lead arranged within the wind turbine rotor blade. A conductive band is placed on top of the heating mat. A bolt has a shaft passing through the conductive band, the conductive mat, and the blade shell and is secured in a threaded nut in the interior of the blade. The current supply lead is pressed between the blade shell and the nut, so that an electrical path for the current is given through the nut and bolt and into the mat and conductive band.

### SUMMARY

It is an object of the disclosure to provide a wind turbine rotor blade with an electrical heating element that can be produced easier and more cost efficiently, and a corresponding method of manufacturing.

This object is solved by various wind turbine rotor blades according to the disclosure

A wind turbine rotor blade includes:
a wind turbine rotor blade shell structure including a fiber reinforced composite material;
an electrical heating element arranged on an outer surface of the wind turbine rotor blade shell structure, the electrical heating element having an electrical heating conductor with an end section;
an electrical supply line running along a longitudinal direction of the wind turbine rotor blade; and
a connector connecting the end section of the heating conductor electrically to the electrical supply line; wherein
the connector includes an outer thread screwed into the fiber reinforced composite material and into the electrical supply line.

The wind turbine rotor blade shell structure has an outer surface which corresponds to an aerodynamic surface of the wind turbine rotor blade. For example, the wind turbine rotor blade shell structure may be wind turbine rotor blade half shell, such as a pressure side half shell or a suction half shell, or a longitudinal segment of such a half shell. An inner surface of the wind turbine rotor blade shell structure is typically directed to a hollow interior space of the wind turbine rotor blade. The wind turbine rotor blade shell structure includes a fiber reinforced composite material which includes reinforcing fibers, such as glass fibers and/or carbon fibers, and a polymer into which the reinforcing fibers are embedded. The fiber reinforced composite material may also be referred to as a laminate. In addition, the wind turbine rotor blade shell structure may include additional components such as a core material, for example a polymer foam or balsa wood, and prefabricated parts. These additional materials may be integrated into the wind turbine rotor blades shell structure, for example in a vacuum infusion process so that all mentioned components will be embedded in a common polymer matrix.

The electrical heating element has at least one heating conductor which is supplied with an electrical heating current so that the outer surface of the wind turbine rotor blade covered by the electrical heating element can be heated in order to prevent the formation of ice (anti-icing) or to remove ice already formed (de-icing) on the outer surface of the wind turbine rotor blade. To guide the electrical heating current through the heating conductor, an end section of the heating conductor is connected to an electrical supply line running along a longitudinal direction of the wind turbine rotor blade. The electrical supply line typically is guided towards a root end of the wind turbine rotor blade where it is connected to a power supply. Typically, both ends of the electrical heating element have an end section connected to an electrical supply line.

The electrical connection between the electrical supply line and the end section of the heating conductor is made via a connector that includes an outer thread screwed directly into the fiber reinforced composite material and into the electrical supply line. This means the outer thread of the connector engages an inner surface of an opening in the fiber reinforced material as well as an inner surface of an opening in the electrical supply line. The openings in both materials are filled by a portion of the connector having the outer thread. The inner surfaces of the fiber reinforced composite material and the electrical supply line include sections having an inner thread or a comparable surface structuring that is in direct engagement with the outer thread of the connector. As a result, the connector cannot be shifted in its longitudinal direction without damaging the inner surface structure of the adjacent fiber reinforced composite material or the inner surface structure of the electrical supply line, respectively.

For inserting the connector into the fiber reinforced composite material and into the electrical supply line, the connector has been screwed in. Correspondingly, for removing the connector without damaging the inner surface of the fiber reinforced composite material and the inner surface of the electrical supply line, the connector would need to be screwed out.

The obtained screw connection is different from a threaded bold just passed through corresponding openings and locked by a nut on the reverse side. The outer thread of the connector is in direct contact with the surrounding fiber reinforced composite material and with the electrical supply line, and is therefore anchored directly in the fiber reinforced composite material and into the electrical supply line.

The electrical contact between the connector and the electrical supply line is provided by the direct engagement of the outer thread of the connector and the adjacent inner surface of a corresponding opening in the electrical supply line.

When making an electrical connection between a threaded connector and an electrical supply line, the one skilled in the art will usually prepare two contact surfaces each being as large as possible, and bring these into immediate contact by applying a pressing force, in particular by clamping both elements together by fastening and nut on the outer thread. Prior art document EP 2 754 891 B1 discussed in the introductory portion follows this approach. The inventors realized that in the specific application of an end section of an electrical heating element arranged on an outer surface of a wind turbine rotor blade, which end section needs to be connected to an electrical supply line of the wind turbine rotor blade, a good electrical contact can also be obtained at the threaded section of the connector when at the same is screwed directly into the electrical supply line. In this case, it is not required to fasten a nut to the connector, which is, if possible at all, at least difficult within the narrow interior space of a wind turbine rotor blade.

The inventors also realized that when the connector is also screwed directly into the fiber reinforced composite material, a sufficient if not better mechanical anchoring of the connector in the wind turbine rotor blade shell structure is obtained.

Overall, the suggested solution provides good electrical contact and is easy to manufacture and therefore superior from an economic perspective.

In an aspect, the outer thread of the connector is self-cutting. This means it is not required to provide the fiber reinforced composite material and the electrical supply line with an inner thread prior to screwing in the connector. Instead, the connector can simply be screwed into the fiber reinforced composite material and into the electrical supply line, preferably after a cylindrical opening has been formed in these materials by drilling a hole with a diameter which is smaller than the outer diameter of the outer thread. The outer thread will then cut a corresponding, tightly fitting inner thread into the fiber reinforced composite material and into the electrical supply line when screwing in the connector. This makes it particularly simple to insert the connector and automatically leads to a good electrical contact between the outer thread and the electrical supply line and to a strong anchoring of the outer thread into the fiber reinforced material.

In an aspect, the connector is electrically connected to the electrical supply line exclusively via the outer thread. This means there is no additional contact between the connector and the electrical supply line except for between the outer thread and the adjacent surface structure of the electrical supply line. It is not required to provide the connector with a nut. It is also not required that between the connector and the electrical supply line, any clamping force is exerted. Further, it is also not required that an additional, indirect electrical contact for example between a head section of the connector and the electrical supply line is formed, for example by placing an electrically conductive sheath therebetween.

In an aspect, the connector includes a head section abutting the end section of the heating conductor. As a result, a good electrical contact is formed between the connector and the end section of the heating conductor. A required clamping force between a bottom face of the head section and the end section of the heating conductor can be obtained by screwing the connector into the fiber reinforced composite material to press the head section against the end section of the heating conductor arranged at the outer surface of the wind turbine rotor blade shell structure.

In an aspect, the connector is a screw having the outer thread. An electrical contact between the connector and the end section of the heating conductor can then be formed directly between an upper end/a head section of the screw.

In an aspect, the connector includes a thread insert having the outer thread and an inner thread. This is a good solution in particular when a relatively large-diameter outer thread is desired to maximize the contact surface along the outer thread. The inner thread can be used for connecting the end section of the electrical heating element via an additional element of the connector.

In an aspect, the connector includes a screw having an outer thread screwed into the inner thread of the thread insert. This screw may have a had section for contacting the end section of the electrical heating element. An electrical connection between the screw and the thread insert is automatically formed via the threaded connection therebetween.

In an aspect, the electrical supply line includes a plurality of braided copper wires. The copper wires may have relatively thin dimensions, such as a diameter in the range of 0.2 mm to 1.5 mm. Braiding these copper wires leads to a flexible supply line having a total cross-section of for example 50 mm². The electrical supply line may have a rectangular cross-section with a width in the range of 20 mm to 40 mm and a thickness in the range from 1.0 mm to 3.0 mm. As a result, a sufficient electrical contact is obtained by screwing the outer thread of the connector into the arrangement of braided copper wires.

In an aspect, the electrical supply line is arranged at an inner side of the rotor blade shell structure. The electrical supply line can then be fixed to the rotor blade shell structure, for example as long as the rotor blade shell structure is still in a manufacturing mold and/or has not yet been assembled with other shell structures to form the complete wind turbine rotor blade.

In an aspect, the electrical supply line is integrated into the rotor blade shell structure. This can be done for example when manufacturing the wind turbine rotor blade shell structure by placing the electrical supply line together with other elements in a manufacturing mold, for example using a vacuum infusion process. This leads to firm integration of the electrical supply line, preferably at an inner side of the rotor blade shell structure, so that the electrical supply line can easily be contacted from the outer side of the wind turbine rotor but shell structure when screwing the connector into the wind turbine rotor blade shell structure.

In an aspect, the end section of the heating conductor includes a cable lug. The cable lug is electrically and mechanically connected to the heating conductor, for example by crimping. The cable lug provides a reliable means for making electrical contact to the electrical supply line via the connector.

In an aspect, the heating conductor includes a metal heating wire or a bundle of carbon fibers. In both alternatives, the electrical resistance of the heating conductor can be selected according to the requirements, for example by choosing the number and/or thickness of the carbon fibers.

The above stated object is also solved by various methods according to the disclosure.

A method is for manufacturing a wind turbine rotor blade and includes the following steps:
providing a wind turbine rotor blade including:
a wind turbine rotor blade shell structure including a fiber reinforced composite material,
an electrical heating element arranged on an outer surface of the wind turbine rotor blade shell structure, the electrical heating element having an electrical heating conductor with an end section,
an electrical supply line running along a longitudinal direction of the wind turbine rotor blade, and
connecting the electrical supply line to the end section of the electrical heating conductor by screwing a connector including an outer thread directly into the fiber reinforced composite material and into the electrical supply line.

With regard to the features and advantages of the method, the above explanations of the related wind turbine rotor blade apply correspondingly. In particular, the connection between the electrical supply line and to the end section of a heating conductor are carried out simply by screwing a connector with an outer thread directly into the fiber reinforced composite material and into the electrical supply line.

In an aspect, the step of connecting the electrical supply line to the end section of the electrical heating conductor includes:
drilling a hole into the wind turbine rotor blade shell structure from an outer side; and
screwing the connector into the hole.

The hole drilled into the wind turbine rotor blade shell structure has a diameter which is smaller than the outer diameter of the outer thread, so that the connector is fastened to the wind turbine rotor blade shell structure by direct engagement between the outer thread and the fiber reinforced composite material. No matter whether the hole is also drilled into the electrical supply line, the outer thread of the connector will be screwed into the electrical supply line as well. In particular in combination with a self-cutting outer thread, it may be sufficient to drill the hole only into the fiber reinforced material. When screwing in the connector, the screw will also find its way into/through the electrical supply line, in particular when the same is arranged below the fiber reinforced composite material and/or is formed by braided copper wires.

### BRIEF DESCRIPTION OF DRAWINGS

The invention will now be described with reference to the drawings wherein:

FIG. 1 shows a wind turbine rotor blade in schematic, perspective view;

FIG. 2 shows a heating element in a schematic view;

FIG. 3 shows a cross-section through the wind turbine rotor blade of FIG. 1;

FIGS. 4 to 6 show schematic cross-sectional views illustrating three manufacturing steps, using a connector including a screw; and,

FIGS. 7 to 9 show three schematic cross-sectional views illustrating manufacturing steps using a connector including a thread insert.

### DETAILED DESCRIPTION

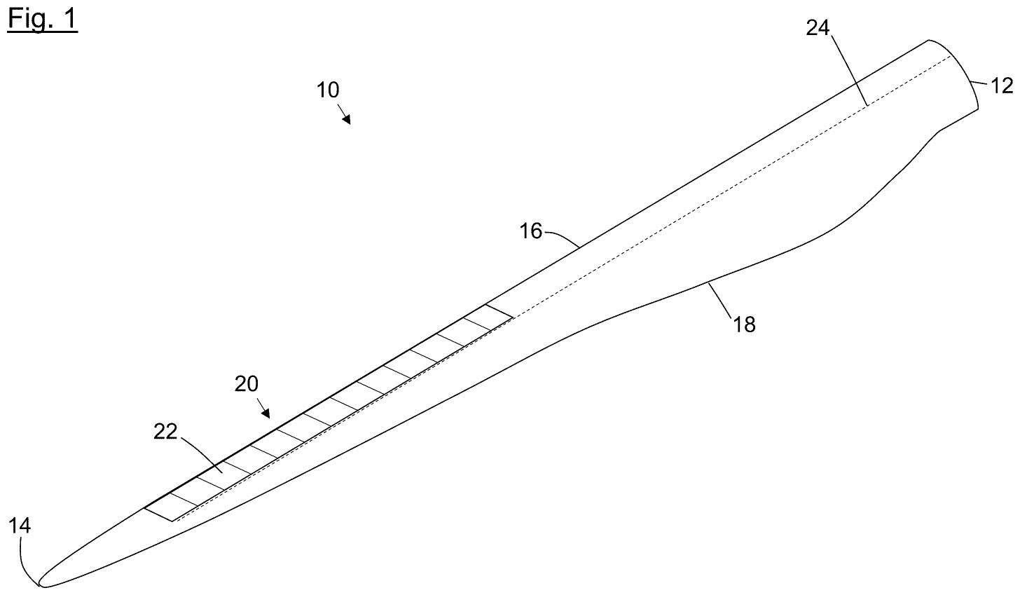

The wind turbine rotor blade 10 of FIG. 1 has a blade root 12, a blade tip 14, a leading edge 16, a trailing edge 18 and a longitudinal direction running from the blade root 12 to the blade tip 14. A heating system 20 includes a plurality of electrical heating elements 22 arranged on an outer surface of the wind turbine rotor blade. The wind turbine rotor blade includes two wind turbine rotor blade half shells, one at a pressure side, one at a suction side, adhered to each other along the leading edge 16 and along the trailing edge 18. Each of the wind turbine rotor blade half shells is a wind turbine rotor blade shell structure.

An electrical supply line is running along the longitudinal direction of the wind turbine rotor blade 10, from the blade root 12 towards an outermost one of the electrical heating elements 22.

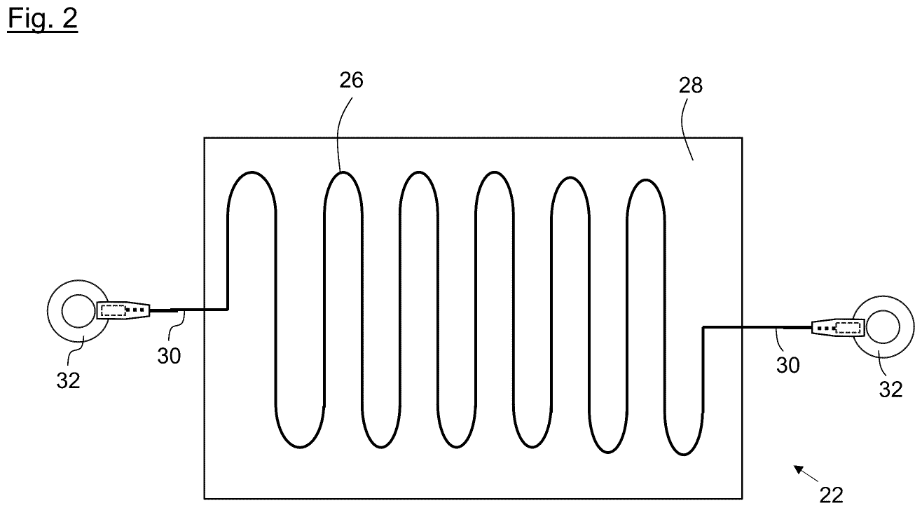

FIG. 2 shows an electrical heating element 22 including an electrical heating conductor 26 arranged in a meandering pattern on a base material 28. The electrical heating conductor 26 has two end sections 30 each provided with a cable lug 32.

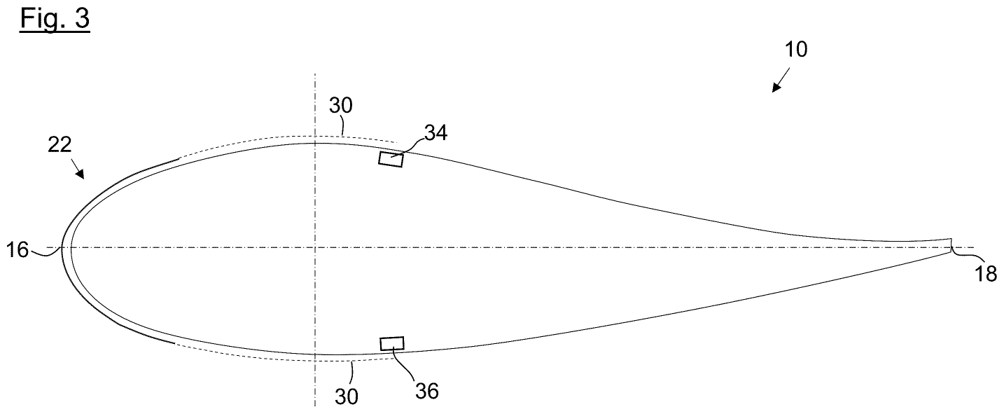

FIG. 3 shows the wind turbine rotor blade 10 of FIG. 1 in cross-section at a longitudinal position which includes one of the electrical heating elements 22. The base material 28 with the meandering section of the electrical heating conductor 26 extends over the leading edge 16. Two electrical supply lines are also shown. A first electrical supply line 34 is arranged at a pressure side of the wind turbine rotor blade 10, a second electrical supply line 36 is arranged at the suction side of the wind turbine rotor blade 10. A first end section 30 of the electrical heating conductor 26 extends up to the first electrical supply line 34, a second end section 30 of the electrical heating conductor 26 extends up to the second electrical supply line 36.

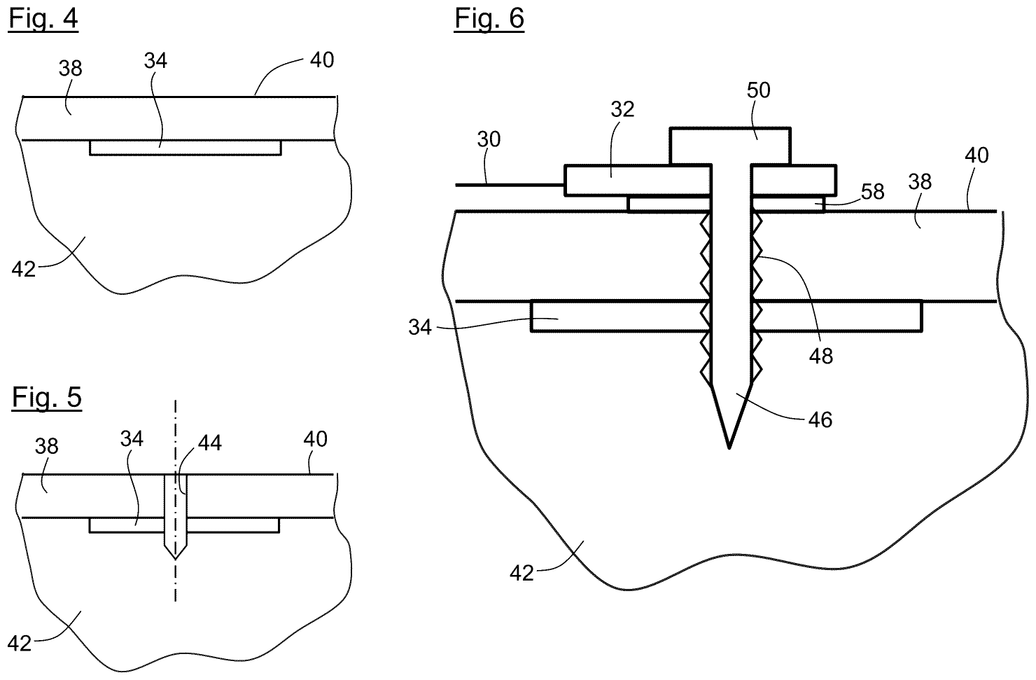

FIG. 4 shows an enlarged section of the cross-section of FIG. 3 including the first electrical supply line 34. The wind turbine rotor blade shell structure includes a fiber reinforced composite material 38, such as a laminate having a thickness in the range of 2 mm to 50 mm, which forms an outer surface 40 of the wind turbine rotor blade shell structure. At the other side of the fiber reinforced composite material 38, the first electrical supply line 34 is arranged. It is surrounded by a core material 42 which is connected to an inner side of the fiber reinforced composite material 38. FIG. 4 shows the situation before the end section of the electrical heating element 22 is mounted.

FIG. 5 shows of the same elements described with reference to FIG. 4 after a cylindrical hole 44 has been drilled through the fiber reinforced composite material 38 and the first electrical supply line 34. The diameter of this hole 44 is less than the diameter of an outer thread 48 of the connector 46 (see FIG. 6).

In FIG. 6, the end section 30 of the electrical heating conductor 26 with the cable lug 32 and a washer 58 below have been placed at the outer surface 40 of the wind turbine rotor blade shell structure, and a connector 46 having an outer thread 48 has been screwed into the hole, directly into the fiber reinforced composite material 38 and into the first electrical supply line 34. As illustrated by the zigzag lines, the outer thread 48 of the connector 46 is in direct engagement with the adjacent inner surface of the fiber reinforced composite material 38 as well as with the adjacent inner surface of the first electrical supply line 34. The connector 46 is thus anchored mechanically in the fiber reinforced composite material 38 and is electrically connected to the first electrical supply line 34 directly via the outer thread 48. The connector 46 further includes a head section 50 abutting the cable lug 32.

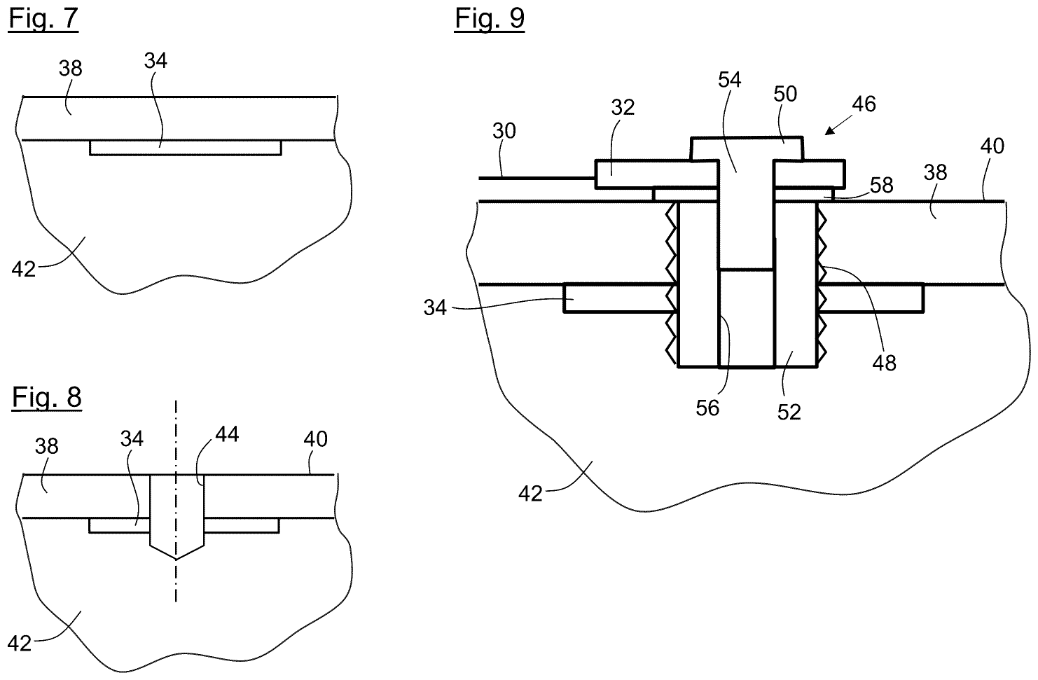

In the example illustrated in FIGS. 7 to 9, the situation of FIG. 7 is identical to the one described with reference to FIG. 4. FIG. 8 differs from FIG. 5 in that a hole 44 with a larger diameter has been drilled through the fiber reinforced composite material 38 and the first electric supply line 34.

FIG. 9 shows that the connector 46, in this case, includes a thread insert 52 having an inner thread 56 and the outer thread 48 which has a larger diameter than the outer thread 48 of the screw-shaped connector 46 of FIG. 6. This thread insert 52 has been screwed in directly into the hole 44 shown in FIG. 8. Again, the outer thread 48 leads to mechanical anchoring of the connector 46 in the fiber reinforced composite material 38 and to electrical connection to the first electrical supply line 34.

In contrast to FIG. 6, FIG. 9 shows a connector 46 including an additional screw 54 which is screwed into the inner thread 56 of the thread insert 52 and is used to fasten and electrically connect the cable lug 32 to the thread insert 52.

It is understood that the foregoing description is that of the preferred embodiments of the invention and that various changes and modifications may be made thereto without departing from the spirit and scope of the invention as defined in the appended claims.

### LIST OF REFERENCE NUMERALS

10 wind turbine rotor blade
12 blade root
14 blade tip
16 leading edge
18 trailing edge
20 heating system
22 electrical heating element
24 electrical supply line
26 electrical heating conductor
28 base material
30 end section
32 cable lug
34 first electrical supply line
36 second electrical supply line
38 fiber reinforced composite material
40 outer surface
42 core material
44 hole
46 connector
48 outer thread
50 head section
52 thread insert
54 screw
56 inner thread
58 washer

1. A wind turbine rotor blade comprising:
a wind turbine rotor blade shell structure including a fiber reinforced composite material;
an electrical heating element arranged on an outer surface of said wind turbine rotor blade shell structure, said electrical heating element having an electrical heating conductor with an end section;
an electrical supply line running along a longitudinal direction of the wind turbine rotor blade;
a connector electrically connecting said end section of the electrical heating conductor to said electrical supply line; and,
said connector including an outer thread screwed directly into said fiber reinforced composite material and into said electrical supply line.

2. The wind turbine rotor blade of claim 1, wherein said outer thread is self-cutting.

3. The wind turbine rotor blade of claim 1, wherein said connector is electrically connected to said electrical supply line exclusively via said outer thread.

4. The wind turbine rotor blade of claim 1, wherein said connector includes a head section abutting said end section of said heating conductor.

5. The wind turbine rotor blade of claim 1, wherein said connector is a screw having said outer thread.

6. The wind turbine rotor blade of claim 1, wherein said connector includes a thread insert having said outer thread and an inner thread.

7. The wind turbine rotor blade of claim 6, wherein said connector includes a screw having the outer thread screwed into said inner thread of said thread insert.

8. The wind turbine rotor blade of claim 1, wherein said electrical supply line includes a plurality of braided copper wires.

9. The wind turbine rotor blade of claim 1, wherein said electrical supply line is arranged at an inner side of said rotor blade shell structure.

10. The wind turbine rotor blade of claim 1, wherein said electrical supply line is integrated into said rotor blade shell structure.

11. The wind turbine rotor blade of claim 10, wherein said electrical supply line is integrated into said rotor blade shell structure in a vacuum infusion process.

12. The wind turbine rotor blade of claim 1, wherein said end section of said electrical heating conductor includes a cable lug.

13. The wind turbine rotor blade of claim 1, wherein said electrical heating conductor includes a metal heating wire or a bundle of carbon fibers.

14. A method of manufacturing a wind turbine rotor blade, the method comprising:
providing a wind turbine rotor blade having a wind turbine rotor blade shell structure including a fiber reinforced composite material, the wind turbine rotor blade further having an electrical heating element arranged on an outer surface of the wind turbine rotor blade shell structure, the electrical heating element having an electrical heating conductor with an end section, the wind turbine rotor blade further having an electrical supply line running along a longitudinal direction of the wind turbine rotor blade; and,
connecting the electrical supply line to the end section of the electrical heating conductor by screwing a connector having an outer thread directly into the fiber reinforced composite material and into the electrical supply line.

15. The method of claim 14, wherein said connecting the electrical supply line to the end section of the electrical heating conductor includes:
drilling a hole into the wind turbine rotor blade shell structure from an outer side; and, screwing the connector into the hole.
